(19) United States
(12) Patent Application Publication
(10) Pub. No.: US 2008/0073139 A1
(43) Pub. Date: Mar. 27, 2008

(54) Struts and methods for installing a wide sized rear tire on a smaller sized tire motorcycle frame

(76) Inventors: Joseph F. Conrad, Harbeson, DE (US); Gary V. Boccadutre, Pittstown, NJ (US)

Correspondence Address: DIEHL SERVILLA LLC, 77 BRANT AVE, SUITE 210, CLARK, NJ, 07066, US

(21) Appl. No.: 11/880,122

(22) Filed: Jul. 19, 2007

Related U.S. Application Data
(60) Provisional application No. 60/807,887, filed on Jul. 20, 2006.

(51) Int. Cl. B62K 11/00

(52) U.S. Cl. 180/227

(57) ABSTRACT

Struts are provided for adapting a Harley-Davidson motorcycle with a standard frame for a 150 mm width rear tire to a frame accommodating a 200 mm tire. Except for the struts Harley Davidson components such as fenders can be used to modify the motorcycle. Measurements of the struts are provided. Methods to install the struts are also provided.

### CROSS-REFERENCE TO RELATED APPLICATION

This application claims the benefit of U.S. Provisional Patent Application No. 60/807,887, filed Jul. 20, 2006, which is incorporated herein by reference in its entirety.

### BACKGROUND OF THE INVENTION

The present invention relates to motorcycles. More specifically it relates to methods and struts to modify an existing motorcycle with a smaller sized rear tire to accommodate a wider rear tire.

Harley-Davidson motorcycles of the Softail pre-2006 models have rear tires that have a maximum width of 150 mm. A significant number of owners of those models would like to install a rear tire of 200 mm width. Such an installation is not just a mere replacement of a wheel and the tire. A larger tire will not fit in the standard Softail model. In order to make the larger tire fit, the whole back-end of the motorcycle has to be modified and includes replacing parts such as fender, swing-arm, etc.

Aftermarket kits, virtually replacing the complete rear end of the motorcycle are available. For many people, using these after-market kits has the drawback that the modified motorcycle will have a significant number of non-Harley Davidson components. This means that the fender and other important parts of the modified bike are no longer Harley Davidson provided parts.

Harley Davidson started producing the 2006 CVO Fatboy which has a 200 mm width tire. This model has a modified frame that is different from the models having 150 mm width rear tires. However it has all the relevant parts such as fenders and swing-arms to accommodate the broader tire. For the aftermarket this means that now the individual parts, marketed by Harley Davidson are available to accommodate a 200 mm width tire.

What is missing is the means to modify the frame of the 150 mm width tire frames to accommodate the 200 mm width tire. Accordingly methods and struts to modify the frames are required.

### SUMMARY OF THE INVENTION

One aspect of the present invention provides a kit to modify a Harley Davidson Softail motorcycle to accommodate a rear tire with a width of 200 mm.

It is another aspect of the present invention provides a first strut and a second strut as components of a modification kit.

It is a further aspect of the present invention to provide a kit to modify a Harley Davidson Softail motorcycle that can use a Harley Davidson manufactured fender.

It is another aspect of the present invention to provide a method to modify a Harley Davidson motorcycle using a modification kit.

It is a further aspect of the present invention to include instructions for modifications in the modification kit.

### DESCRIPTION OF THE DRAWINGS

FIG. 1 shows a motorcycle frame.

FIG. 2 shows a picture of a strut.

FIG. 3 shows a drawing of a strut.

FIG. 3a shows further details and measurements of a strut from a view.

FIG. 3b shows further details and measurements of a strut from a view.

FIG. 3c shows further details and measurements of a strut from a view.

FIG. 4. shows another drawing of a strut from another view.

FIG. 4a shows further details and measurements of a strut from another view.

FIG. 4b shows further details and measurements of a strut from another view.

FIG. 5. shows a flow diagram of a method for modifying a motorcycle.

FIG. 6 shows a detailed portion of a modified strut.

FIG. 7 illustrates part of a part list used to modify a Harley Davidson motorcycle in accordance with one aspect of the present invention.

FIG. 8 illustrates another part of a part list used to modify a Harley Davidson motorcycle in accordance with one aspect of the present invention.

FIGS. 9 and 10 illustrate a Harley Davidson motorcycle modified in accordance with an aspect of the present invention.

### DESCRIPTION OF A PREFERRED EMBODIMENT

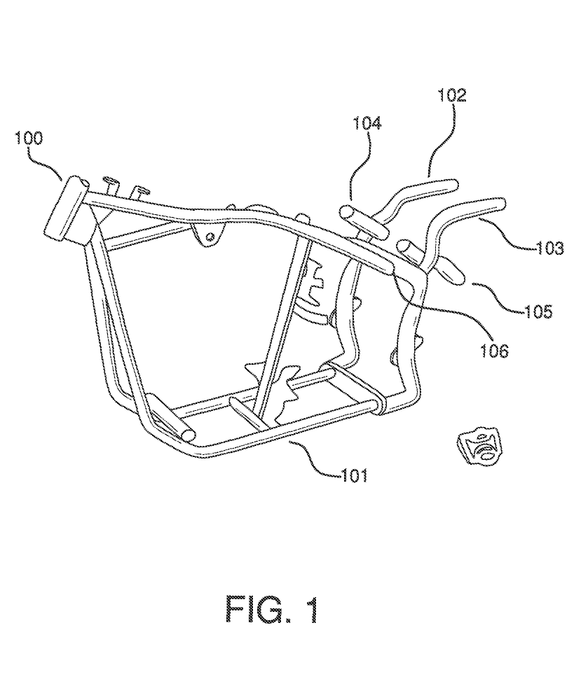

It is one aspect of the present invention to use as much of the frame of a motorcycle to be modified as possible. The present frame of a Softail models has a rear end that is too narrow to hold a wheel with a 200 mm width tire. Consequently that part of the frame has to be widened. FIG. 1 shows a frame that is commonly used in a motorcycle and that is representative for the frame as used in the Harley-Davidson Softail models. In FIG. 1, 100 identifies to front of the frame, 101 identifies the bottom. In FIGS. 1, 102 and 103 identify the right and the left horn of the frame. The horns carry the fender and weight from the saddle. Consequently the horns provide an important part of the structural integrity of the motorcycle. However in the standard configuration of the Softail motorcycle, the horns cannot accommodate a 200 mm width tire.

It is another aspect of the present invention to remove the horns 102 and 103 above structural member 106, removing as much of the horns so that structural member 106 is nearly flush.

Because a strut has to contribute to the structural strength of the frame and has to carry significant weight it is another aspect of the present invention that the strut is manufactured from metal or strong carbon fiber material. In one preferred embodiment a strut is manufactured from an aluminum alloy. For instance it can be machined from a 6061-T6 Aluminum Alloy Bar. Alternate materials could be: 7075 aluminum alloy, steel, cast iron. The struts can also be made from other metal alloys. Fiber resin composites, including carbon, glass, aramid, PBO or quartz can also be used. The struts can be manufactured by machining. Casting from molds can also be applied and can include methods like: sand cast, permanent molds, investment mold and lost core resin.

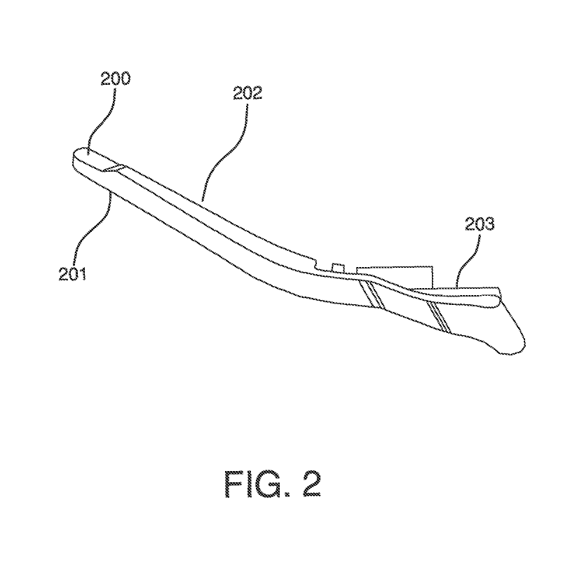

FIG. 2 shows a picture of a left side strut. In FIG. 2, 201 is the top side when the strut is mounted on a motorcycle, and 202 is the bottom. In FIG. 2, the area around 203 shows the jump or offset in the strut that allows the widening that will accommodate the broader tire to fit between the struts fitted to the horns. In FIG. 2, 203 is the extended part of the strut to which for instance the fender is attached. A left strut is a strut that will be attached to the bike on the left side facing forward. The right strut, which is part of a frame modification kit, is the mirror image of the left strut and has the same measurements and placements of holes, but in a conjugate manner.

The frame of the motorcycle already has holes drilled in them. In fact, close to 106 in FIG. 1 showing a frame there are holes that may be used to attached and fixate existing fender strut covers.

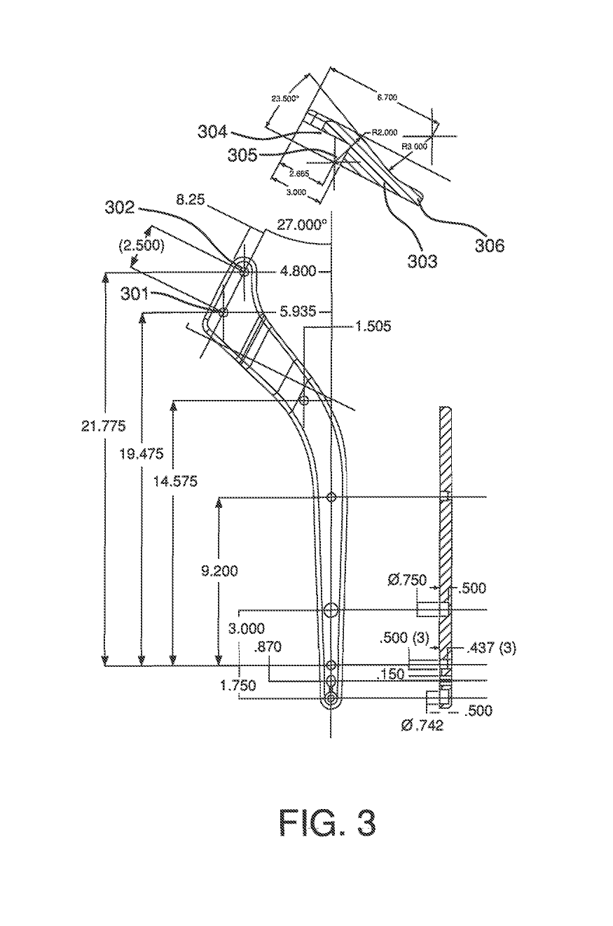

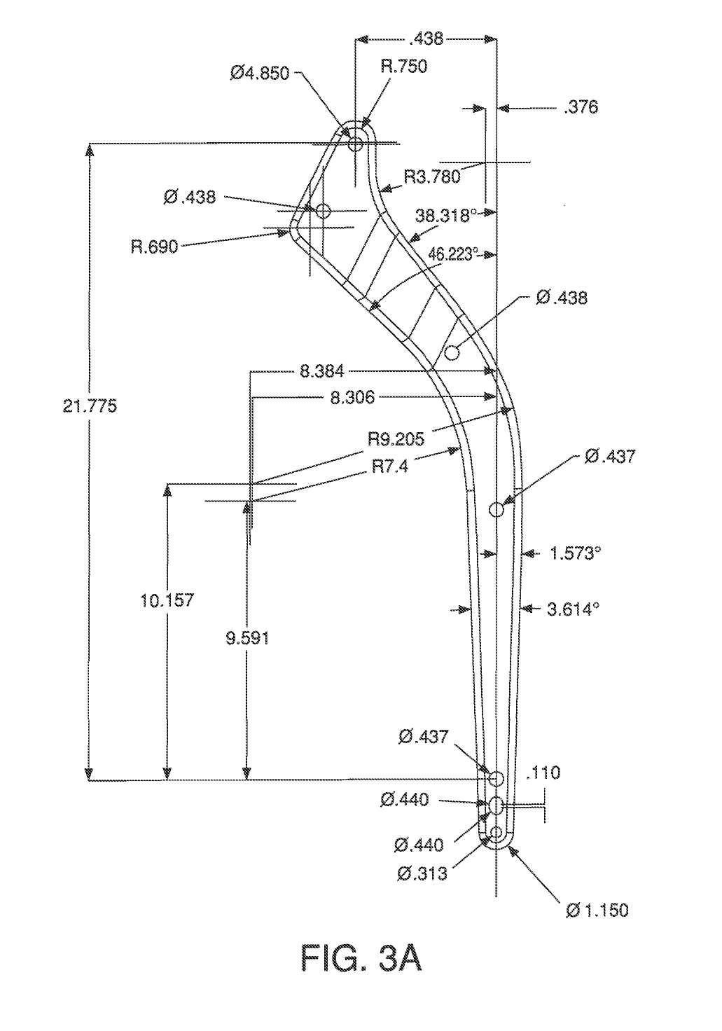

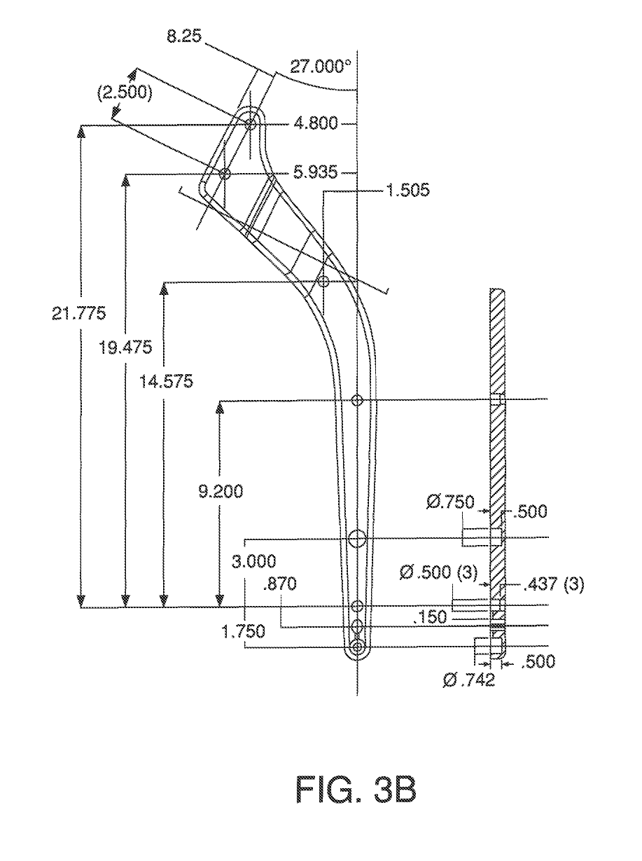

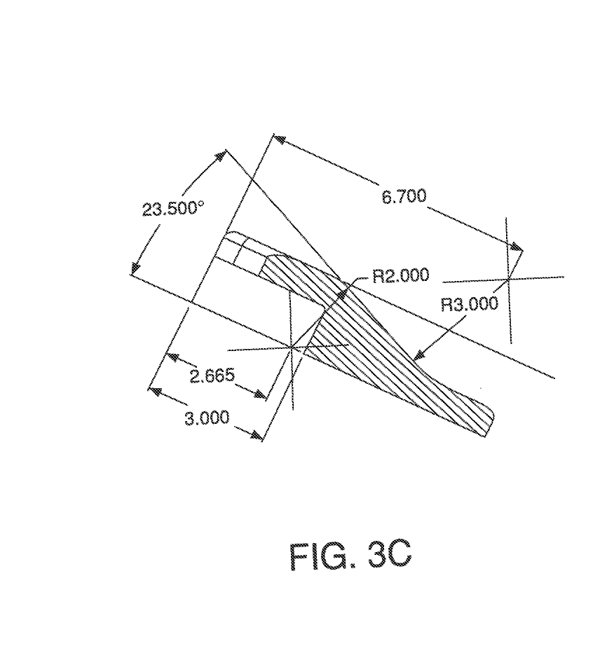

FIG. 3 shows a technical drawing of a left strut in accordance with one aspect of the present invention. In FIG. 3, 300 is a technical drawing of the left strut in top view. The numerals 301 and 302 are holes in the left strut that will line up exactly with the earlier identified holes close to structural member 106 in the frame of the motorcycle. In FIG. 3, 303 is a technical drawing of the left strut in a side view. It shows that the strut has two flat surfaces 304 and 305. Surface 304 has the two holes 301 and 302. To fit and fixate the left strut one should align the holes 301 and 302 with the holes in the frame, rest surface 304 against the frame and rest surface 305 on top of the surface of the structural member 106 as identified in FIG. 1. FIG. 3a, FIG. 3b and FIG. 3c show further details and measurements of a strut in accordance with one aspect of the present invention. It should be clear to one skilled in the art that certain degrees of freedom exist for the measurements. However it should also be clear that measurements that determine the alignment of a strut with the frame of the motorcycle, such as the distance between the two holes for bolting a strut to the frame, as well as measurements of the strut that determine fitting with an appropriate fender and those that determine the accommodation of a 200 mm width rear tire are preferred and in the preferred embodiment do not allow for significant divergence of the provided measurements. Also the design and realization of the strut allows for selecting the correct strut for the correct side of the motorcycle, finding the correct place for attaching the strut, correctly aligning the strut and tightly attaching the strut to the frame by bolting a strut to the frame through the holes in the frame and the strut.

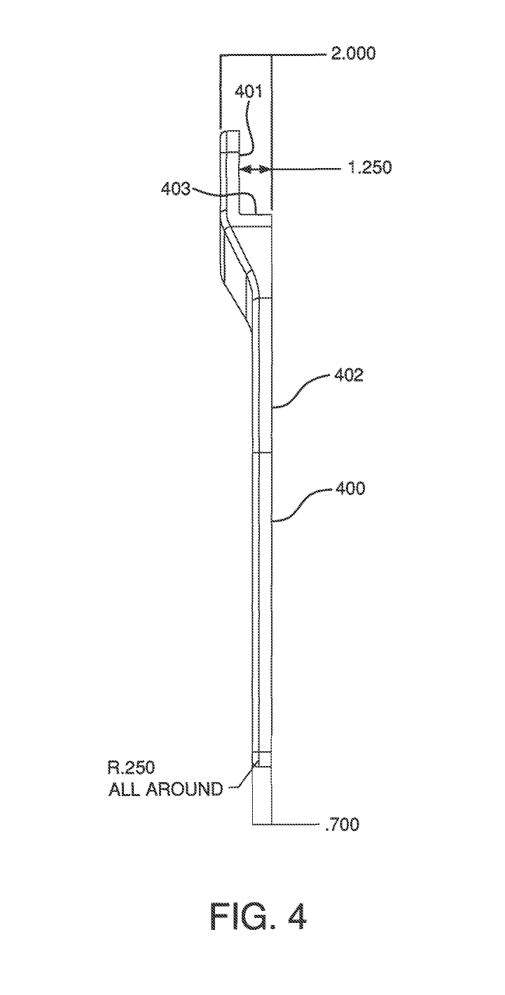

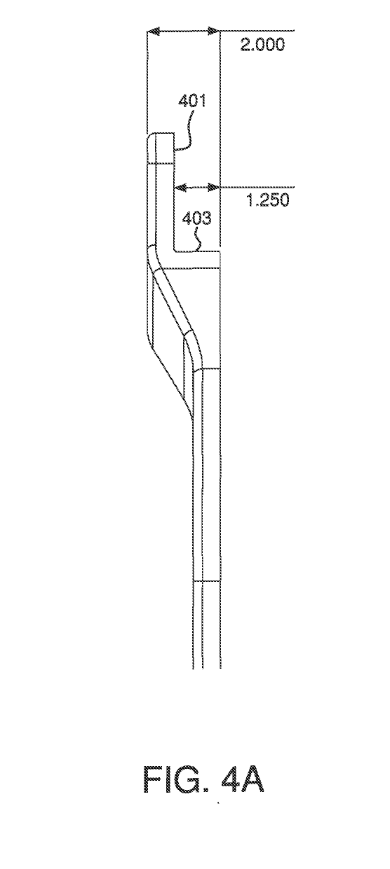

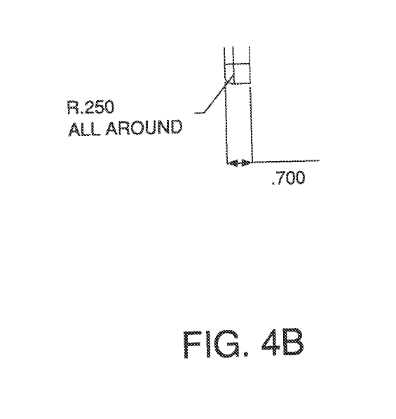

It is a further aspect of the present invention to provide the correct measurements to the struts so that the struts fixated to the motorcycle frame will accommodate the 200 mm tire. This aspect is demonstrated in FIG. 4. Now referring to FIG. 4 which shows a side view of a strut 400 which is an aspect of the present invention. In FIG. 4 401 shows the area that will be bolted to the frame and 402 shows the part that will hold the fender. The offset 403 between area 401 and the area 402 is created in such a way that the space between a left strut and a right strut attached to the frame of a Softail motorcycle will provide the right space to attach a fender and accommodate a tire of a width of 200 mm. Further details of the offset and the measurements are provided in FIG. 4a and FIG. 4b Though the preferred embodiment of attaching the struts to the frame is by bolting, it should be clear that the struts can also be welded and glued to the frame, depending on, for instance, the material the struts are made of.

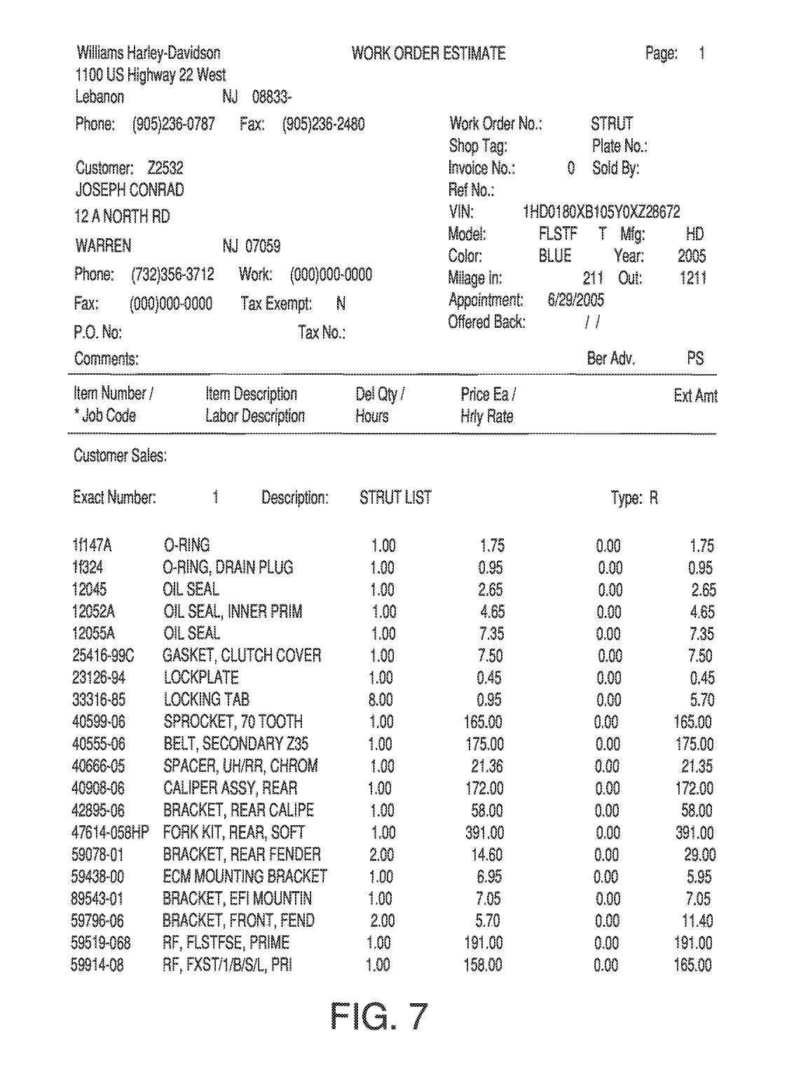

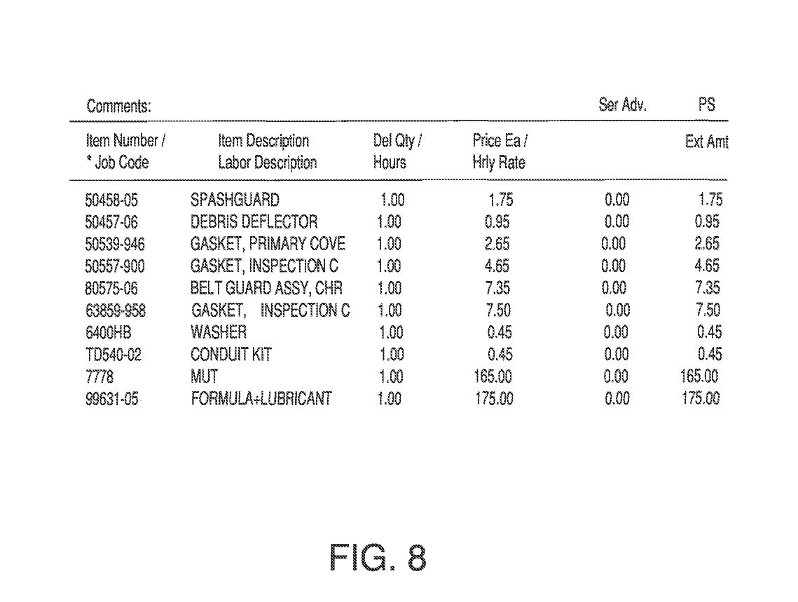

A method of installing the struts, which is another aspect of the present invention, comprises disassembling a Softail motorcycle removing the homs, attaching the struts and re-assembling the motorcycle. A parts list for the method of the present invention is illustrated in FIGS. 7 and 8. In accordance with a further aspect of the present invention the method includes the following steps:

Remove the seat

Remove the battery and electrical box (ECM) that is mounted on the fender

Disconnect the brake light, and turn signals

Unbolt the fender strut covers and remove the fender

Remove the rear wheel

Remove the rear swing arm

Remove old drive belt

Install the new drive belt

Install the new swing arm

Cut the horns off the frame

Install the new wheel and tire

Install new Brake caliper and bracket

Align appropriate holes in the struts with holes in the frame

Bolt the new fender to the Left Strut and the Right Strut

Bolt fender and struts to bike frame

Reinstall turn signals and brake light

Reinstall the electrical box (ECM)

Reinstall the battery

Reinstall the seat

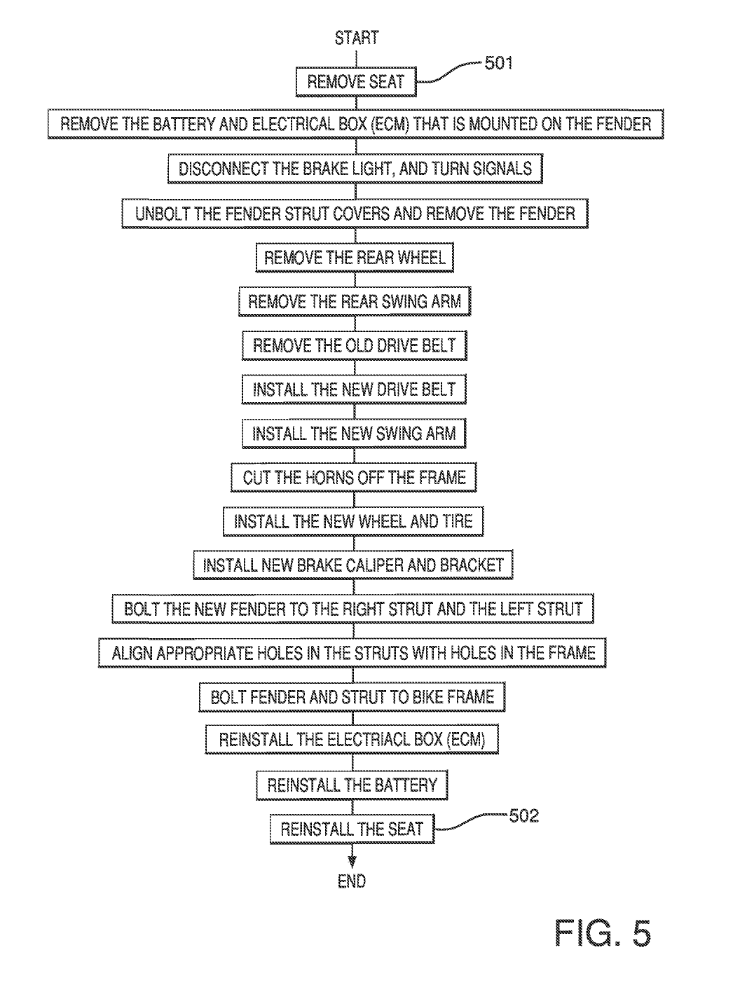

The steps of the methods of installing the struts are shown in a flow diagram in FIG. 5, starting with step 501 of removing the seat and completing the method by step 502 of reinstalling the seat.

The struts, which are one aspect of the present invention are comprised of a left strut and a right strut. The drawings of FIG. 3 and FIG. 4 show the dimensions of a left strut. The right strut is an exact mirror image of the left strut with the same measurements and relative positions of holes.

It is another aspect of the present invention that installing the left strut and right strut does not require drilling additional wholes in the frame. Accordingly, the holes 301 and 302 in the left strut and the corresponding holes in the right strut have to be 2.5 inches apart.

It is another aspect of the present invention that when the left strut and the right strut are attached to the fender required for a 200 mm width rear tire, they are well fit to be attached to the motorcycle frame by bolting the struts to the frame. The struts have to provide an offset that will enable the attachment of the struts with the fender to the frame and accordingly as shown in FIG. 4 the surfaces of the strut as identified by 401 and 402 have to be parallel and have an offset of 1.25 inch.

The measurements of the struts in accordance with a preferred embodiment of the present invention are provided in the FIGS. 3, 3a, 3b, 3c, 4, 4a, 4b and 6. The units of measurement are inches.

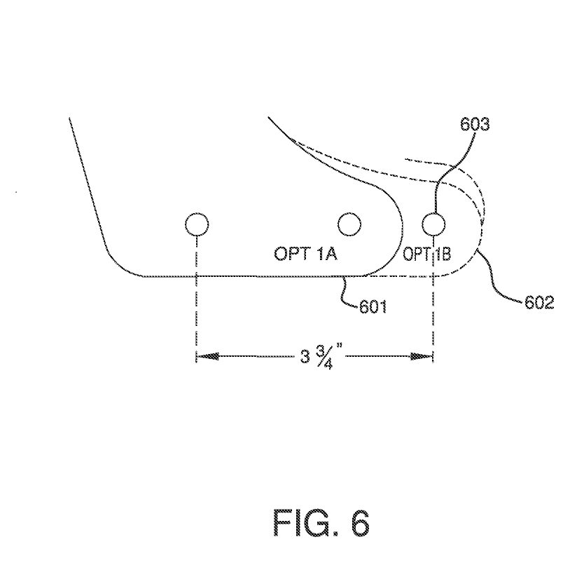

It is one aspect of the present invention to also use struts to accommodate Harley Davidson models such as FXST/FXSTI, FXSTB/FXSTBI and FXSTS/FXSTSI for 200 mm width tires. These and potentially other models may use the struts provided here in modified form, by extending one part of the strut and adding one hole. This is shown in FIG. 6. In FIG. 6, 601 shows a part of the strut as also shown in FIG. 3. In FIG. 6, 602 shows a modified strut with a hole 603 added. Hole 603 matches an existing hole in a frame of the previously mentioned motorcycle models. Accordingly, it is one aspect of the present invention to modify the strut provided in the present invention for different motorcycle frames. It should be clear to those skilled in the art that additional modifications to the strut to accommodate different frames are possible. These modifications are fully contemplated as an aspect of the present invention.

The struts provided as an aspect of the present invention can be used to modify the Softail model series of Harley Davidson motorcycles. More specifically the struts can be used on the following models of HARLEY DAVIDSON SOFTAIL LINE OF MOTORCYCLES:

Softail Standard—FXST/FXSTI

Night Train—FXTB/FXTBI

Springer Softail—FXSTS/FXSTSI

These bikes can be retro fitted for models from 2000 to 2005.

Fat Boy—FLST/FLSTI

These bikes can be retro fitted for models from 2000 to 2006.

Softail Deluxe—FLSTN/FLSTNI

Springer Classic—FLSTSC/FLSTSCI

These bikes can be retro fitted for models from 2000 to 2006, but require changing the taillight.

Heritage Softail Classic—FLSTC/FLSTCI

These bikes can be retro fitted for models from 2000 to 2006.

The struts can be part of a frame modification kit. In a first embodiment the modification kit comprises a left strut and a right strut. The struts can be marketed and provided in a single kit, using appropriate packaging. In another embodiment the modification kit includes components such as bolts, nuts, screws and washers. In a further embodiment the kit includes instructions for attaching the struts to the motorcycle. In a further embodiment the kit includes strut covers. In another embodiment the struts are painted or receive a surface treatment. The paint or surface treatment may provide a color to the strut that matches the color of the fender. The surface treatment may also provide different colors. In a further embodiment the modification kit includes a Harley Davidson fender for a 200 mm width rear tire.

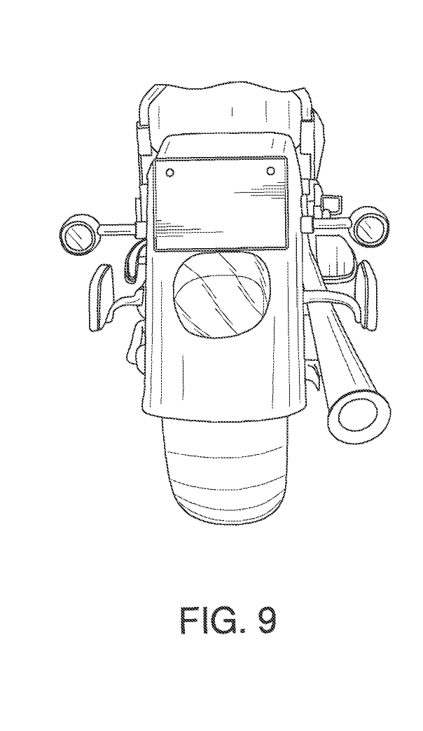

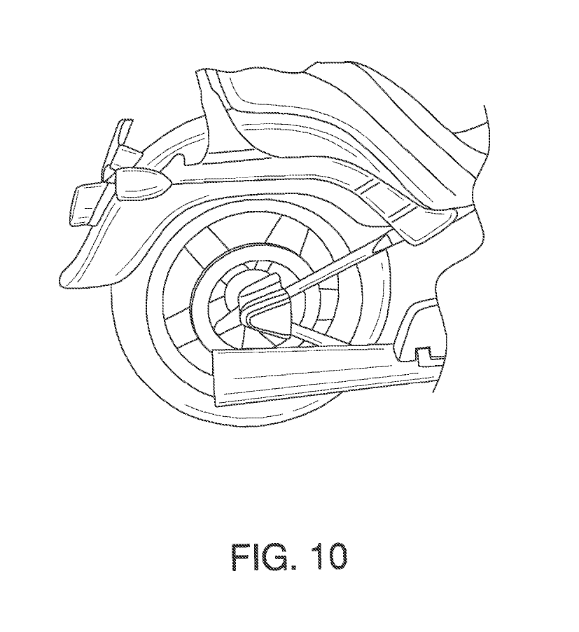

FIGS. 9 and 10 illustrate a Harley Davidson motorcycle modified in accordance with one aspect of the present invention.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A kit for modifying a motorcycle with a first size rear tire to accommodate a second larger size rear tire, comprising: a first strut and a second strut being the conjugate of the first strut.

2. The kit as claimed in claim 1, wherein the kit includes additional components to attach the first strut and the second strut to the motorcycle.

3. The kit as claimed in claim 1, wherein the kit includes instructions for attaching the first strut and the second strut to the motorcycle.

4. The kit as claimed in claim 1, wherein the first strut comprises two holes that align with two holes in a first defined location in a motorcycle frame and the second strut comprises two holes that align with two holes in a second defined location in the motorcycle frame and wherein the motorcycle frame having the first strut attached through the two holes in the first defined location and having the second strut attached through the two holes in the second defined location will accommodate a rear tire with a width of 200 mm.

5. The kit as claimed in claim 1, wherein the first strut has two parallel surfaces of which the minimum distance of the surfaces is 1.25 inch.

6. The kit as claimed in claim 1, wherein the motorcycle is a Harley Davidson Softail motorcycle.

7. The kit as claimed in claim 7, wherein the first size rear tire is 150 mm and the second size rear tire is 200 mm.

8. The kit as claimed in claim 1, further comprising a first and second strut cover for the first and second struts, respectively.

9. The kit as claimed in claim 1, wherein the first and second struts are painted.

10. The kit as claimed in claim 1, wherein the first and second struts are surface treated.

11. The kit as claimed in claim 1, wherein the first and second struts are made from aluminum alloy.

12. The kit as claimed in claim 1, wherein the first and second struts are made from cast iron.

13. The kit as claimed in claim 1, wherein the first and second struts are made from steel.

14. The kit as claimed in claim 1, wherein the first and second struts are made from a metal alloy.

15. The kit as claimed in claim 1, wherein the first and second struts are mirror images of each other with the same measurements.

16. A method of using the kit of claim 2, comprising assembling the first and second struts to a frame of the motorcycle using existing holes in the frame.
